(19) United States
(12) Patent Application Publication
(10) Pub. No.: US 2013/0041697 A1
(43) Pub. Date: Feb. 14, 2013

(54) RESERVATION DISPLAY SYSTEM

(71) Applicants: Kevin Bergot, London (GB); John Hyland, London (GB); Senan Sexton, London (GB)

(72) Inventors: Kevin Bergot, London (GB); John Hyland, London (GB); Senan Sexton, London (GB)

(21) Appl. No.: 13/207,165

(22) Filed: Aug. 10, 2011

(51) Int. Cl. G06Q 10/02

(52) U.S. Cl. 705/5

(57) ABSTRACT

A reservation display system, comprising a server, a terminal configured to receive reservation data and a plurality of display devices, said server being configured to receive reservation data from the terminal, the reservation data comprising information about the reservation of an object or area in the vicinity of at least one of the display devices, the server being configured to host at least one predetermined web page, said at least one predetermined web page being configured to display said reservation data and wherein each display device is configured to wirelessly access a predetermined web page, such that each display device has its own predetermined webpage, each display device being configured to automatically access and display its predetermined webpage such that each display device displays reservation concerning the reservation of an object or area in the vicinity of each display device, the system being further configured to support a reboot operation, such that said display devices automatically reboot after an elapsed time period and wherein each display device automatically displays its predetermined web-page after rebooting.

Embodiments of the present invention are concerned with display systems and methods which are configured to display reservation information.

It is often desirable to display information about who has reserved an object or area in such a way that one approaching the object or area can easily obtain the information. This has traditionally been achieved by providing paper or other notices. This is not convenient because in many cases, the information relating to the object of the area can be changing quickly so paper notices become cumbersome.

For example, in hostels or the like a guest will stay in a bed in a room. However, there will be many beds to one room. A typical problem in the hostel industry is that a guest will be told at reception to go to one bed in the room, but the guest may accidentally occupy a different bed. This then causes problems for the next guest who is told to go to a bed which the receptionist believes is free but which has been accidentally occupied by another guest. This causes considerable problems in the hostel industry and considerable loss of revenue in that beds will need to be changed more often if they are accidentally occupied.

Paper notices are not suitable and could not be changed reliably to address the above issues.

The present invention attempts to at least partially address the above problem and in a first aspect provides a reservation display system, comprising a server, a terminal configured to receive reservation data and a plurality of display devices, said server being configured to receive reservation data from the terminal, the reservation data comprising information about the reservation of an object or area in the vicinity of at least one of the display devices, the server being configured to host at least one predetermined web page, said at least one predetermined web page being configured to display said reservation data and wherein each display device is configured to wirelessly access a predetermined web page, such that each display device has its own predetermined webpage, each display device being configured to automatically access and display its predetermined webpage such that each display device displays reservation concerning the reservation of an object or area in the vicinity of each display device, the system being further configured to support a reboot operation, such that said display devices automatically reboot after an elapsed time period and wherein each display device automatically displays its predetermined web-page after rebooting.

The system may be configured to perform the reboot operation automatically a plurality of times per day. In one embodiment, each display device has its own unique predetermined webpage, in other embodiments a common predetermined webpage is used for all or a selection of display devices.

The reservation data may be directly accessed from an automatic booking system. The reservation data may additionally or alternatively be entered at an entry terminal.

In one embodiment, the display devices are tablet PCs. The tablets are configured to access their predetermined webpage. This allows the system to be easily maintained as a tablet can be easily replaced if it is damaged. It is also possible to add new tablets to the system.

In one embodiment, the display devices are configured to perform a refresh operation after a predetermined time interval so that each display device will re-access its webpage.

The webpage held on the server may also comprise links to other webpages.

In a second aspect, the present invention provides a method of operating a reservation display system, the display system comprising a server, a terminal and a plurality of display devices,
the method comprising:
configuring a server to host at least one predetermined web page, said at least one predetermined webpage displaying reservation data, said reservation data comprising information about the reservation of an object or area in the vicinity of at least one of the display devices such that each display device has its own predetermined webpage;
updating the at least one predetermined web page on the server using information from the terminal;
wirelessly accessing the server via a display device, such that each display device displays its predetermined webpage;
rebooting the system such that each display device restarts and automatically accesses its predetermined webpage.

The description is mainly concerned with providing a system which displays bed reservations in a hostel. However, it can be applied to any system where reservations are made and it is necessary for the guest to be able to identify the entity they have reserved, be it a theatre seat, cinema seat, restaurant table, seat in a sports stadium etc.

### BRIEF DESCRIPTION OF DRAWINGS

The present invention will now be described with reference to the following non-limiting embodiments in which:

FIG. 1 is a schematic of a display system configured for a hostel in accordance with an embodiment of the present invention;

FIG. 2 is a schematic of the network system used in the system of FIG. 1;

FIG. 3 is a schematic of a screen used to update the displays in the system described with reference to FIGS. 1 and 2;

FIG. 4 is a schematic of a network system used in accordance with an embodiment of the present invention;

FIG. 5 is a schematic of a display screen used in accordance with an embodiment of the present invention;

FIG. 6 is a flow diagram showing some of the operations performed by a system in accordance with an embodiment of the present invention; and

FIG. 7 is a display system configured for reserving seats in accordance with an embodiment of the present invention.

### DETAILED DESCRIPTION OF EMBODIMENTS

Systems in accordance with embodiments the present invention can be used in a wide variety of applications.

As an example, first, the system will be discussed in relation to a hostel reservation system. In hostels, such as youth hostels or the like, a visitor to the hostel will reserve a bed in a room. Typically, there will be many beds in a room. Therefore, it is necessary for the visitor to be able to easily identify their bed.

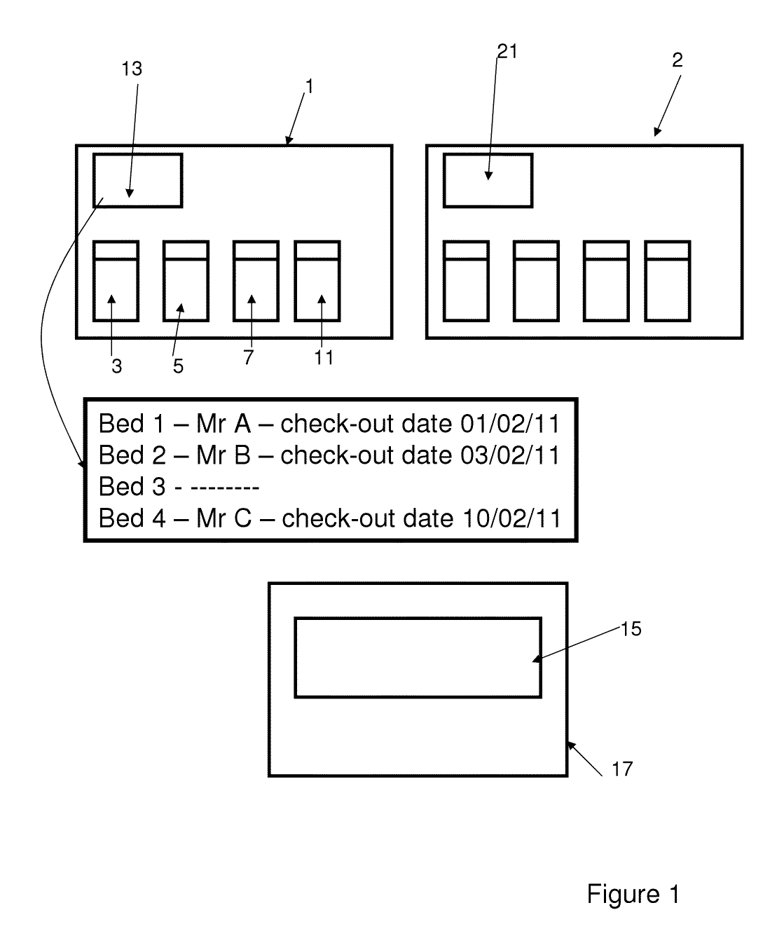

In FIG. 1, two rooms, a first room, 1 and a second room, 2 are shown. In this particular example, the rooms are identical with the same number of beds. However, it will be appreciated this is not necessary. For the purposes of the remainder of the explanation, only room one will be described in more detail.

Room 1 has four beds, 3, 5, 7 and 11. Also, a display 13 is provided in room 1. In this particular example, the display 13 is positioned in the actual room 1. However, the display could easily be positioned on the door of the room or just outside the room.

The display indicates the occupant of each bed and, in this particular example, the date when that person checks out.

In this example, Bed 1 is occupied by Mr A who checks out on date Jan. 2, 2011, Bed 2 is occupied by Mr. B who checks out 2 days later, Bed 3 is not occupied and bed 4 is occupied by Mr C who is checks out on Oct. 2, 2011.

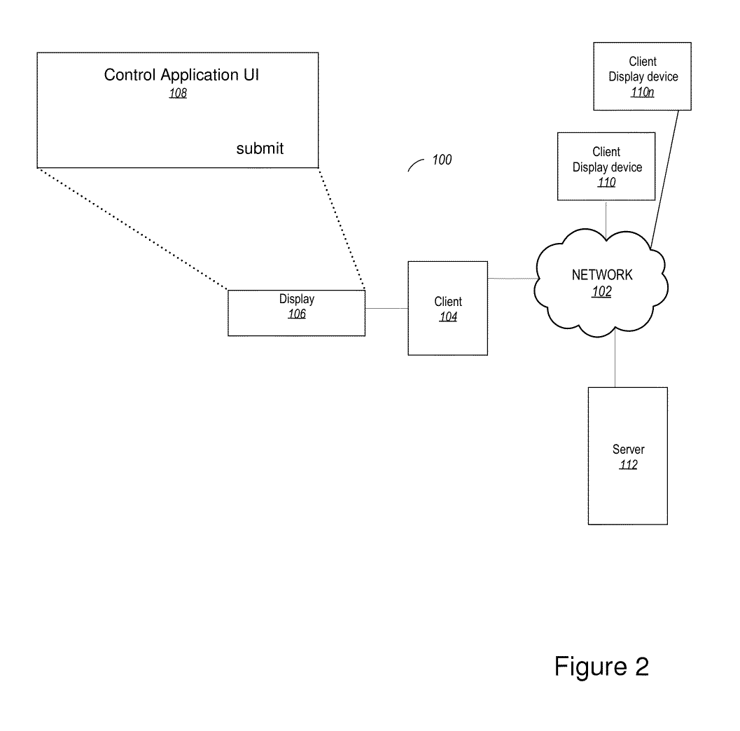

In this particular embodiment, the display 13 is the display of a tablet PC. The Tablet PC displays a webpage which contains the information shown in FIG. 1. The information on the display 13 is updated via computer 15 which is located in reception 17. How the display 13 is updated will be described in more detail with reference to FIGS. 2 to 6.

The computer 15 located in the reception is also used to update display 21 which is located in room 2.

Although in FIG. 1, computer 15 is shown in reception 17, it is possible for the information which is provided on displays 13 and 21 to be inputted from a different remote location. In one embodiment, the system is linked to an automatic booking system which is booked by the Internet or the like.

FIG. 2 is a diagram which shows an example of a system used to update the displays 13 and 21 of FIG. 1.

The display system 100 comprises a plurality of display devices 110 which represent the displays 13 and 21 of FIG. 1. The system further comprises a server 112 and an entry terminal 104.

The display devices 110 and entry terminal 104 are connected to server 112 via a network 102. Each of the devices 104, 110 and 112 can run web applications. The entry terminal 104 is configured to receive input corresponding to reservation data from the control application 108 displayed by display 106.

In this embodiment, the server 104 hosts one or more webpages which contain information relating to the reservation information such as that described with reference to FIG. 1. In one embodiment, a single web page contains the information for all rooms, in a further embodiment, each room has its own web page which contains information relevant to the reservations of beds in that room.

Each display device runs a web browser which accesses the webpage of the room on the server. The display device displays this webpage. The entry terminal 104 is used to update the webpage content held at the server 112.

For example, the entry terminal 104 can be a device, such as, but not limited to, a desktop computer, a laptop computer, a tablet computer, a personal data assistant (pda), a mobile telephone or any other like device. In general all such devices have but are not limited to, a CPU, memory including RAM, ROM, and other mass storage, input/output components including (display/touch screen, mouse, keyboard), and a network interface so as to allow communication with other devices over a network. The network interface can include wired communication technologies such as telephone lines, fiber optic lines, wireless communication technologies, such as WiFi, WiMAX, or a combination of both.

The server 112 can comprise, for example, a web server. A web server is a software component that responds to an HTTP request with an HTTP reply. As illustrative examples, the web server may include but is not limited to the following, an Apache HTTP Server, an Apache Tomcat, a Sun Java System Web Server or a WebLogic Application Server. The web server may serve content such as hypertext markup language (HTML), extendable markup language (XML), documents, videos, images, multimedia features, graphical user interfaces, or any combination thereof.

The interaction between the entry terminal 110 and the server 112, and between the server 112 and the display device 110 will now be described. The entry terminal 104 communicates with the server device 112 sending information using a network interface over network 102.

In one embodiment, the client device 104 receives an input from the user via the control application user interface 108, the information received is processed and subsequently transmitted to the server 112 using conventional communication means. In one embodiment, a network connection between the entry terminal 104 and server 112 is established over network 102 using a protocol such as TCP from the TCP/IP protocol suite. The data is then transmitted from the entry terminal 104 to the server 112 using a protocol such as FTP the data is processed at the application layer and subsequently handled by lower layers of the protocol stack until it is finally transmitted at the data link layer.

As an example of the above, the entry terminal runs WYSIWIG Software connected by FTP to the server 112 by internet access. The WYSIWIG software on the entry terminal 104 has a corresponding HTML page for each room. Upon check in, the receptionist updates the guest information on the WYSIWIG software and then saves and publishes the page to the server. The FTP Software Updater instructs the server to both erase any old web page held for the room which is being updated and publish the new page. This way the information is only temporarily stored and then erased.

In one embodiment, the HTML page contains an “Iframe”. Details concerning the reservation information such as the bed to be occupied, the checkout date, the name of the occupant outlaw are inserted into the Iframe.

In a further embodiment, the use of FTP to push the information from the entry terminal 104 to the server 112 is removed. Here, the entry terminal directly connects to the server and is configured to update a file on the server by modifying the file on the server 112 as opposed to uploading a new file to replace the file on the server.

This may be achieved by, for example, running a program such as a WYSIWIG Javascript editor on the server 112. Here, the entry terminal 104 will connect to the server 112 via a secure password protected link.

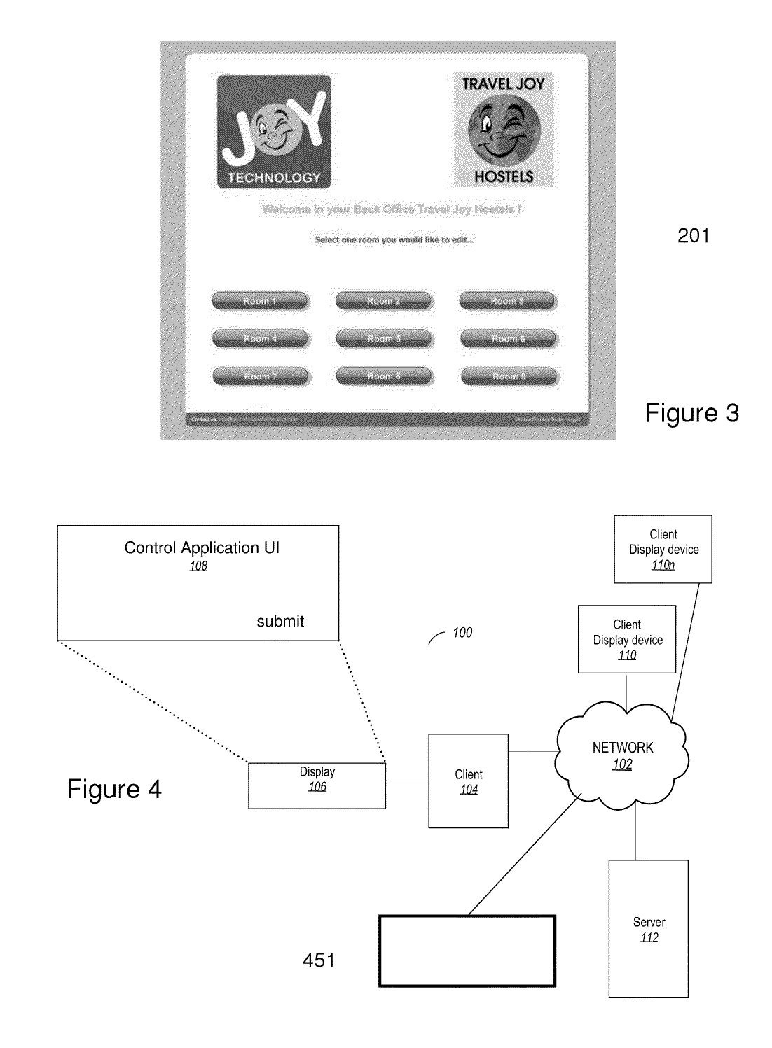

FIG. 3 is an image of a screen which can be logged onto using entry terminal one of four. Screen 201 has, in this particular example 9 rooms, room 1. . . room 9, which may be edited. If for example, the user wishes to update the information for room 4, they will click on room 4 and update reservation details concerning the occupancy of beds in room 4.

When the user has finished, they will then click save and the WYSIWYG JavaScript editor will instruct the server to update the room page.

The above embodiment removes the necessity to push information from the reception to the server using FTP. By allowing the entry terminal to log onto the server and amend information at the server, it is possible to provide improved user-friendly functions.

Further, it is possible to have a single server to manage the reservations in a number of different hostels. Also, in this arrangement, the reception updates one room at a time, there is a reduced chance of error.

In the above embodiments, the server 112 is an external server and the entry terminal 104 connects to the external server 112 via the Internet. However, it is also possible for the server 112 to be an internal server and for the entry terminal 104, the server 112 and the display devices 110 to be connected via an intranet system.

In this embodiment, the entry terminal 104 is connected via internet protocol to intranet server 112 using a secure password protected link.

The entry terminal 104 will be able to access the server 112. The server 112 will display a page to the entry terminal similar to that described with reference to FIG. 3 and the entry terminal will be able to update reservation data for each room in the same way as described with reference to FIG. 3.

The provision of an intranet system, provides greater security since the reservation data does not travel outside the hostel intranet system. Further, intranet system is far faster than an Internet-based system.

Also, the system can be provided as a standalone package and does not need to rely on the installation of a broadband line. Further, as the server is in-house, there is no need to rely on third party server maintenance systems.

In the above system as with the earlier described systems, the customers name and date of departure is stored for as long as the guest stays and is not retained for any longer.

In the embodiment, described with reference to FIG. 4, the system is linked to an automated booking system. The server 112 is updated directly from the automated booking system and there is no need for data to be entered directly at the hostel.

In the hostel industry, customer bookings are fed by different booking portals e.g. Hostel World, Hostel Bookers & Hostel Club. Different types of booking software are used by hostels to handle these bookings e.g. Dorm Book, Charts & ASSD. Each of these booking systems automatically updates availability on the other portals i.e. if a booking comes through Hostel World, availability is reduced on Hostel Bookers. This is made possible by XML code. The common denominator between all these booking software systems is that they allow reports to be generated by CSV file.

FIG. 4 shows a schematic of a system in accordance with an embodiment of the present invention interfacing to an automated booking system.

The system is based on the system described with reference to FIG. 2. Therefore to avoid any unnecessary repetition, like reference numerals will be used to denote like features. Terminal 451 is a server of an automated booking system it is connected to the internet 102. A CSV file containing data about the bookings can be downloaded from the terminal 451 to online server 112 either directly or via a local terminal. In an alternative embodiment, the CSV file may be sent by other means from the booking software, for example by e-mail. The CSV file will contain the name of the person who has made the reservation, the dates they have reserved and also the bed and room which they will occupy.

The CSV file is then placed in a local folder which is in the Hard Drive of a local terminal (not shown), usually located within each hostel. Online server 112 is then synchronised with the Local folder. In an embodiment, the online server 112 is the same as the central server of FIG. 2.

The online server 112 contains a PHP script in an admin folder which is coded to enable the transfer of the CSV file to HTML pages. The online server 112 is instructed by a terminal usually located at the hostel via GNU Wget software script to launch the transformation from CSV file to HTML pages via PHP code.

The GNU Wget software is launched via a configurated Tasks Scheduler on the terminal. For example, the launch may be set at every two hours.

The above system is based on an internet connection.

By automatically collecting the booking data from a hostel booking system, it is possible for no data entry to be performed at the hostel.

All hostels have internet connections and the system described with reference to FIG. 4 will use this connection. The system of FIG. 4 will use a very small amount of broadband data speed. However, if the system uses the hostel's existing broadband, it will be reliant on the broadband data capability not to be over-used. Therefore, in one embodiment, a dedicated broadband line is given to the system.

It is possible that the hostel will also get a “Walk-In” booking. Therefore, in one embodiment, the hostel reception can access the server via the previously described systems. When a “Walk-in” booking checks in, the reception at the hostel will input the reservation information into booking software which will update the CSV file. In a further embodiment, the hostel can rely on the updating of the CSV file for a walk-in booking to update the webpage at the on-line server.

Next, the display devices 110 will be described. A web browser (not shown) installed on display device 110 makes a request to server 112, which hosts web pages and responds according to the client request using a protocol such as HTTP. HTTP is used to transfer web page information from a server 112 to the web browser on display device 110.

The browser is configured to make a request by extracting the hostname section from a Uniform Resource Locator (URL). The Domain Name System (DNS) is used to form a mapping to its corresponding IP address. The IP address is then used to form a connection to the server 112 by using a protocol such as Transmission Control Protocol (TCP). Once a connection is established, the browser on client device 110 and server 112 use HTTP to communicate and a copy of the specific webpage requested is received by the browser on the client device 110. In order to display updated reservation information the web page is requested again from the server after a time has elapsed.

A request is made by a browser on client device 110 to the server 112 for the updated webpage content. Each web page accessed and displayed on a particular device has a unique URL that is specific to the location of the device.

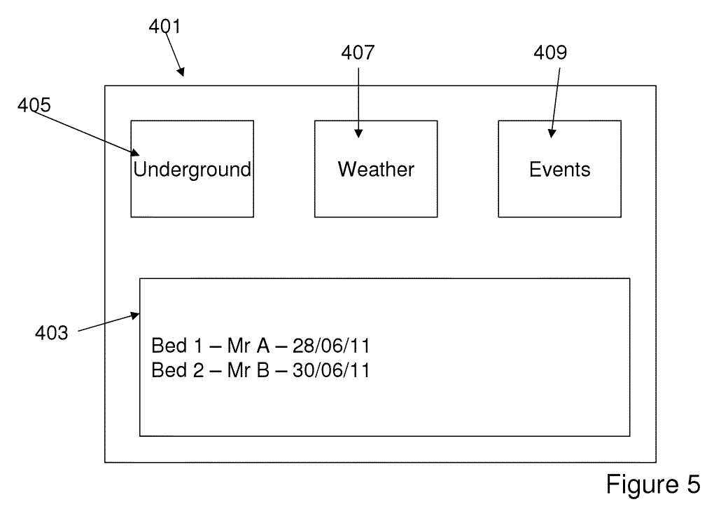

FIG. 5 is a schematic of the page displayed by display device. The display 401 is a reservation information area 403. The reservation information area 403 will, in the case of the hostel, indicate the occupancy of each bed in the hostel room. In this particular example, one display is provided per room. However, it may be possible for one display to relate to a number of different rooms. In this particular example, the reservation area 403 is defined by an Iframe.

In addition to the reservation area 403, the display 401 also displays, in this particular example, three other information links which are underground map 405, weather 407 and events 409. The underground link 405 takes the user to a map of the underground. In jurisdictions outside the United Kingdom, this could be a map of any useful local transport system. The link 407 will allow a user to select weather reports. Link 409 will allow the user to look at various local events.

The links 405, 407 and 409 provided on the display 401 will usually connected to an external Internet page. This is even the case where the server is an internal server. Links to other types of information may be provided in addition to or instead of the above links.

In addition, each webpage is configured to automatically refresh by making frequent subsequent requests to the web server so as to display updated reservation information. Thus, once a page has been uploaded to the server, each display device will load a new page during its next refresh cycle.

In one embodiment, the auto refresh uses meta refresh tag code. In this particular embodiment, the refresh cycle takes place every 30 seconds.

The display system is also configured to reboot. Thus, if there are any problems with the system, for example, if one of the display devices has hung or if the display devices are left on a page other than the page relating to the reservation, the display devices will automatically reset themselves during the day.

In one embodiment, each display device is configured to reboot three times during the day. During the reboot operation each display device is configured to restart. When it restarts, it automatically starts its web browser and the web browser automatically accesses the web address for the room page relevant to the location of the display.

This ability to automatically start has particular advantages. For example, in the case of a power interruption, there is no need to reset each terminal, every terminal should restart and access the correct page.

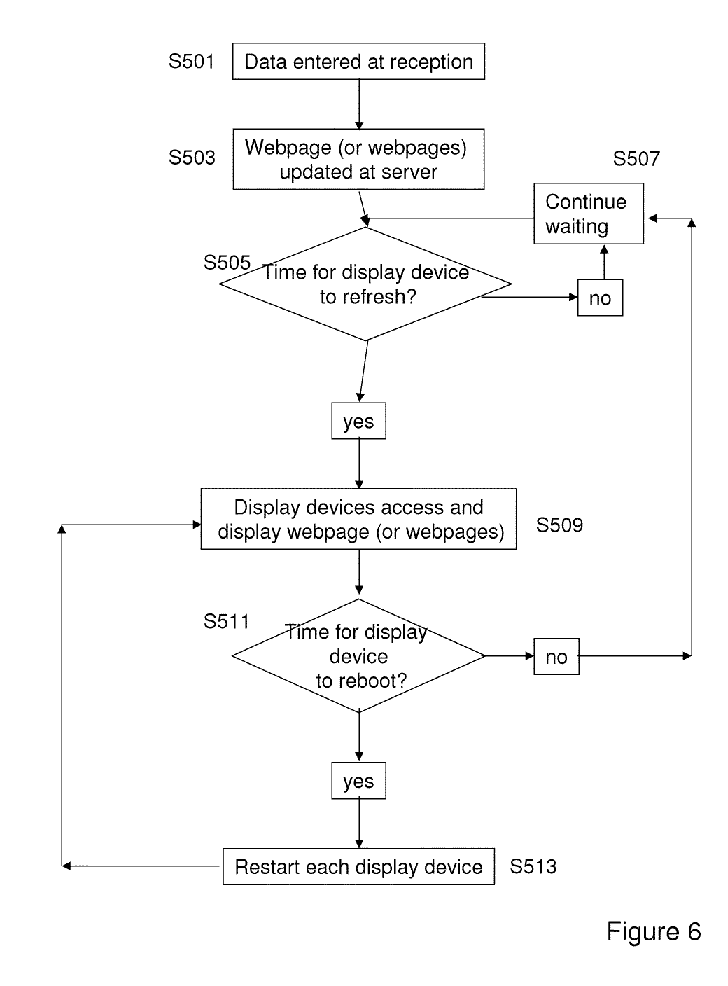

The operation of the overall system will now be described in more detail, with reference to FIG. 6.

At step S501, data is entered at the reception data entry terminal. This process causes a web page to be updated at a server. The data entry terminal at the reception may be configured to directly modify a webpage on the server or it may be configured to upload a new file to a server in step S503.

The webpages are accessed via the display devices in the rooms. In one embodiment, each display device will access a different page. In a further embodiment, one page is provided for all display devices and each display device will access the same page. At step S505 each display device checks to see if it is time for it to refresh its webpage. If it is not, then the display devices will continue waiting in step S507. In one embodiment, each display device refreshes every 30 seconds. However, this time could be longer or shorter dependent on the demands of the system. All display devices could be set to refresh at the same time or the refresh times could be staggered.

If a display device recognises that it is time to refresh, for example, if certain time has elapsed since the last refresh, then it will proceed to step S509. At this stage, the display device will access and display their webpages on from the server.

The display device checks at step S511 if it is time to reboot. As explained above, in one embodiment, the display devices will reboot automatically a plurality of times during the day, for example three times during the day. If its not time to reboot, then the display devices will continue to wait in step S507. The display devices will then check to see if it is time to refresh in step S505 and will re-enter the refresh loop.

If it is time for a display device to reboot, the display device will reboot in step S513. As part of the rebooting procedure, the display device will go back to step S509 and the display devices will access and display the webpages automatically. Again, all display devices may reboot at the same time or the rebooting may be staggered.

The above system has been described with reference to a hostel. However, it is possible to extend the above system to many other uses, for example, university halls of residence, hospitals etc.

It could also be used for dinner reservations in restaurants to advise people where they are sitting. It can also be used in sports arenas, cinemas, theatres, on trains in aeroplanes etc to label the seats where people are sitting.

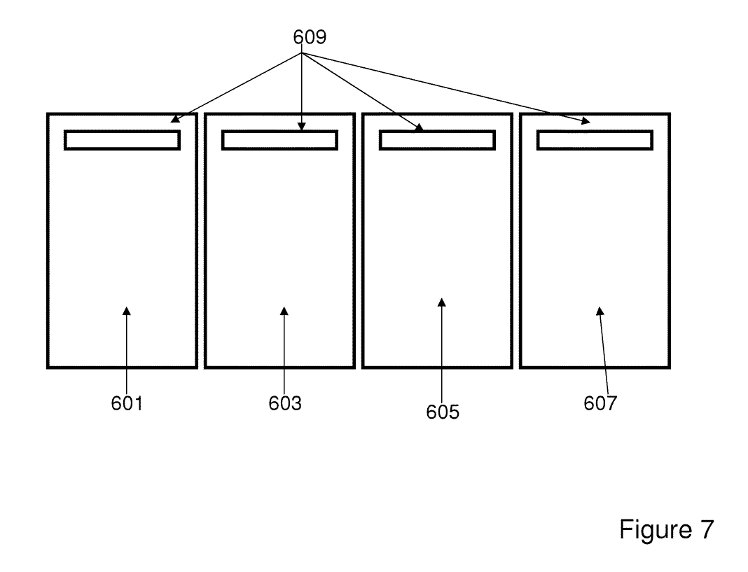

Such an example is shown in FIG. 7 which shows a schematic of a row of seats 641, 603, 605, 607. The back of each of the seats is provided with a small display device 609. Each display device is configured to display the name of the person who are sitting in the seat behind. Therefore, each person can see their name in front of them when they sit down so that they know that they have the correct seat. For such a use, the display devices 609 may be smaller than those used in the hostel reservation and would typically only display the person's name. However, the remainder of the system will be the same. For example, the system will be provided with the same refresh facilities and rebooting facilities which allow the names to be constantly updated without involving extra labour.

In further embodiments, the display devices 609 may also provide be provided with links to transport facilities or other useful information. For example, for theatre seats, the display devices could be provided with a link to the theatre program, map of the theatre, location of the nearest facilities etc.

Some embodiments, may include a machine-readable medium (e.g., a disk drive or memory device) on which is stored one or more sets of instructions and data structures (e.g., software) embodying or used by any one or more of the methodologies or functions described herein. The instructions may also reside, completely or at least partially, within a main memory and/or within a processor during execution thereof by a computer system, the main memory and the processor also constituting machine-readable media.

While machine-readable medium in an example embodiment may be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible (non-transitory) medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable storage media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

1. A reservation display system, comprising:
a server,
a terminal configured to receive reservation data; and
a plurality of display devices;
said server being configured to receive reservation data from the terminal, the reservation data comprising information about the reservation of an object or area in the vicinity of at least one of the display devices, the server being configured to host at least one predetermined web page, said at least one predetermined web page being configured to display said reservation data and wherein each display device is configured to wirelessly access a predetermined web page, such that each display device has its own predetermined webpage, each display device being configured to automatically access and display its predetermined webpage such that each display device displays reservation concerning the reservation of an object or area in the vicinity of each display device, the system being further configured to support a reboot operation, such that said display devices automatically reboot after an elapsed time period and wherein each display device automatically displays its predetermined web-page after rebooting.

2. The display system of claim 1, wherein the system is configured to perform the reboot operation automatically a plurality of times per day.

3. The display system of claim 1, wherein the server is configured to host a plurality of predetermined webpages, the plurality of predetermined webpages each displaying information concerning different locations such that a display device in a location can display a webpage only concerning the reservations in the vicinity of a display device.

4. The display system of claim 1, wherein the server is configured to host at least one web page which provides reservation data concerning a plurality of locations, such that a plurality of display devices have a common predetermined webpage.

5. The display system of claim 1, wherein the said terminal is configured to access a file from an automated booking system.

6. The display system of claim 1, wherein the said terminal is configured to accept data entry from a user located at the terminal.

7. The display system of claim 1, wherein the data concerning a reservation comprises a name of the person or entity associated with the reservation.

8. The display system of claim 1, wherein the reservation system is configured to display data relating to reservations of beds in a hostel, restaurant tables, seats in theatres, cinemas, sports stadiums, trains or aircraft.

9. The display system of claim 1, wherein the display devices are tablet PCs.

10. The display system of claim 1, wherein the terminal transfers data to the server via FTP protocol.

11. The display system of claim 1, wherein the terminal is configured to directly modify data on the server.

12. The display system of claim 1, wherein the server is configured to access a file concerning reservation data on said terminal.

13. The display system of claim 12, wherein the server is configured to access said file and automatically translate it to HTML code to allow the predetermined webpages to be updated.

14. The display system of claim 1, wherein the server and display devices are connected via an intranet.

15. The display system of claim 1, further configured to perform a refresh operation after a predetermined time interval so that each display device will re-access its webpage.

16. The display system of claim 1, wherein the webpage held on the server comprises links to other webpages.

17. The display system of claim 16, wherein the other webpages are held on servers different to those of the server which hosts the at least one predetermined web page.

18. A method of operating a reservation display system, the display system comprising a server, a terminal and a plurality of display devices,
the method comprising:
configuring a server to host at least one predetermined web page, said at least one predetermined webpage displaying reservation data, said reservation data comprising information about the reservation of an object or area in the vicinity of at least one of the display devices such that each display device has its own predetermined webpage;
updating the at least one predetermined web page on the server using information from the terminal;
wirelessly accessing the server via a display device, such that each display device displays its predetermined webpage;
rebooting the system such that each display device restarts and automatically accesses its predetermined webpage.

19. A non-transitory machine-readable medium comprising instructions which, when performed on a system, cause the system to:
configure a server to host at least one predetermined web page, said at least one predetermined webpage displaying reservation data, said reservation data comprising information about the reservation of an object or area in the vicinity of at least one of a plurality of display devices such that each display device has its own predetermined webpage;
update the at least one predetermined web page on the server using information received from a terminal;
wirelessly access the server via a display device, such that each display device displays its predetermined webpage;
reboot the system such that each display device restarts and automatically accesses its predetermined webpage.
